(19) United States
(12) Patent Application Publication
(10) Pub. No.: US 2013/0277870 A1
(43) Pub. Date: Oct. 24, 2013

(54) METHOD OF MANUFACTURING A NANO-LAYERED LIGHT GUIDE PLATE

(71) Applicants: Jehuda GREENER, Rochester, NY (US); Joseph Dooley, Midland, MI (US); Michael R. Landry, Wolcott, NY (US)

(72) Inventors: Jehuda GREENER, Rochester, NY (US); Joseph Dooley, Midland, MI (US); Michael R. Landry, Wolcott, NY (US)

(73) Assignee: SKC Haas Display Films Co., Ltd., Cheonan-si (KR)

(21) Appl. No.: 13/450,316

(22) Filed: Apr. 18, 2012

(51) Int. Cl. G02B 6/00; B82Y 40/00

(52) U.S. Cl. 264/1.24; 977/882

(57) ABSTRACT

The present invention provides a method of manufacturing a nano-layered light guide plate comprising, forming by a coextrusion method a multi-layered molten sheet comprising a plurality of two or more different alternating material layers and casting the coextruded sheet into a nip between a pressure roller and a pattern roller to form a nano-layered sheet having a discrete micro-pattern on at least one principal surface thereof. In addition, the invention further provides cutting and finishing the extruded micro-patterned sheet to form the nano-layered light guide plate, comprising a plurality of two or more different alternating material layers, with each layer having a thickness of less than a quarter wavelength of visible light.

### FIELD OF THE INVENTION

The present invention relates to a method of manufacturing a nano-layered polymeric light guide plate comprising a plurality of at least two alternating layers, and more particularly, to a coextruded nano-layered polymeric light guide plate comprising a plurality of alternating layers of at least two different materials.

### BACKGROUND OF THE INVENTION

Liquid crystal displays (LCDs) continue to improve in cost and performance, becoming a preferred display technology for many computer, instrumentation, and entertainment applications. Typical LCD mobile phones, notebooks, and monitors comprise a light guide plate for receiving light from a light source and redistributing the light more or less uniformly across the LCD. Conventional light guide plates are typically between 0.4 millimeter (mm) and 2 mm in thickness. The light guide plate should be sufficiently thick in order to couple effectively with the light source, typically a cold cathode fluorescent lamp (CCFL) or a plurality of light emitting diodes (LEDs), and redirect more light toward the viewer. Also, it is generally difficult and costly to make a light guide plate with a thickness smaller than about 0.8 mm and a width or length greater than about 60 mm using the conventional injection molding process. On the other hand, it is generally desired to slim down the light guide plate in order to lower the overall thickness and weight of the LCD, especially as LEDs are becoming smaller in size. Thus, a balance must be struck between these conflicting requirements in order to achieve optimal light utilization efficiency, low manufacturing cost, thinness, and brightness. Conventional light guide plates are thick and cumbersome, typically having a thickness that exceeds that of the LCD panel itself. Another drawback relates to the relative inflexibility in the choice of materials used to fabricate conventional light guide plates. Two very common polymeric materials used to fabricate light guide plates for LCD backlights or for general illumination applications are poly(methyl methacrylate) (PMMA) and polycarbonate (PC). When fabricated from PMMA or from other acrylic-based materials, the light guide plate can be brittle and easily breakable if it becomes too thin. When fabricated from PC, the light guide plate has excellent mechanical properties but it can be easily scratched or marred by adjacent films. There are other materials mentioned in relation to the fabrication of light guide plates for LCD but such materials are rarely used due to high cost or some performance deficiency.

In most applications, the light guide plate must be patterned on one side (“one-sided light guide plate”) in order to achieve sufficient light extraction and redirection ability. However, in some cases, e.g., in turning film systems, micro-patterning on both sides of the plate (“double-sided light guide plate”) is desired. The use of a turning film in a backlight unit of a LCD may reduce the number of light management films needed to attain sufficiently high levels of luminance. Unfortunately, achieving good replication of both patterns when the plate is relatively thin (<0.8 mm) has been a major barrier in the acceptance of the turning film option. Indeed, the choice of a method for producing thin, double-sided light guide plates is crucial for controlling cost, productivity and quality, making the turning film technology more economically attractive.

The method of choice for manufacturing one- or two-sided LGPs heretofore has been the injection molding process and some variants thereof. In this process a hot polymer melt is injected at high speed and pressure into a mold cavity having micro-machined surfaces with patterns that are transferred onto the surfaces of the solidified molded plate during the mold filling and cooling stages. Injection molding technology is quite effective when the thickness of the plate is relatively large (≧0.8 mm) and its lateral dimensions (width and/or length) are relatively small (≦300 mm). However, for relatively thin plates (<0.8 mm) with micro-patterns on both principal surfaces, the injection molding process, which requires significant levels of injection pressure, typically leads to poor replication and high residual stress and birefringence in the molded plate, giving way to poor dimensional stability and low production yields.

Another approach used to produce one-sided light guide plates is to print a discrete micro-pattern of round dots on one side of a flat, extruded cast sheet using inkjet, screen printing or other types of printing methods. This process is disadvantaged in that the extrusion casting step requires an additional costly printing step and the shape and dimensions of the discrete micro-extractors are predetermined and not well-controlled. This approach is useful when patterns are changed frequently but it becomes much less attractive when both surfaces are to be patterned and production volumes are relatively high.

The advantages in fabricating a reduced-profile light guide plate are well appreciated by those skilled in the illumination arts. In acknowledgement of the inherent advantages of thin and flexible light guide structures for illumination, a number of solutions have been proposed. For example, U.S. Pat. No. 7,565,054 entitled “Ultra Thin Lighting Element” by Rinko describes a flexible illuminator formed as a waveguide and using patterns of discrete, diffractive structures for light extraction. In all cases, the light guide plate is homogeneous, comprising a single material and a single light conducting layer.

The choice of polymeric materials for use in light guide plates for LCD backlights is dictated by the demanding optical and physical performance requirements of the waveguide and the LCD. Generally, the material must possess very high optical transmittance, very low chromaticity, good environmental and dimensional stability and high abrasion resistance, among other requirements. In addition, the material must be melt-processable and relatively inexpensive in order to meet the cost requirements of this product class. These stringent requirements limit the choice of polymeric resins to very few material options. As noted, two leading resin classes used today in LCD light guide plates are PMMA and PC. Each of these materials has special strengths but each also suffers from a number of serious drawbacks. For example, while PMMA has excellent optical properties and very high abrasion resistance, it is very brittle and has borderline environmental stability. By comparison, PC has excellent mechanical properties and good environmental stability but its optical properties, especially light transmittance, are somewhat inferior to those of PMMA and its abrasion resistance is poor. Also, not all plastic materials can be reliably fabricated to thin gauges without risk of brittleness and cracking. For example, PMMA, although mentioned in the '054 Rinko patent, would prove difficult to fabricate at a thickness below 0.3 mm. Fabrication methods for this solution would also be challenging using existing techniques and conventional materials.

Thus, there is a need for a robust and low cost light guide plate that combines the desirable features of both resin classes while minimizing the impact of their adverse characteristics. The new material composition must also facilitate efficient extraction, distribution and redirection of light for use in LCD and other types of display devices as well as in general illumination applications.

### SUMMARY OF THE INVENTION

The present invention provides a method of manufacturing a nano-layered light guide plate comprising: forming by a coextrusion method a multi-layered molten sheet comprising a plurality of two or more different alternating material layers; casting the coextruded sheet into a nip between a pressure roller and a pattern roller to form a nano-layered sheet having a discrete micro-pattern on at least one principal surface thereof; and cutting and finishing the extruded micro-patterned sheet to form the nano-layered light guide plate, comprising a plurality of two or more different alternating material layers, with each layer having a thickness of less than a quarter wavelength of visible light.

In another embodiment, the present invention provides a method of manufacturing a nano-layered light guide plate comprising: forming by a coextrusion method a multi-layered molten sheet comprising a plurality of two or more different alternating material layers; casting the coextruded sheet onto a flat surface and cooling the sheet to create a solid blank nano-layered slab; printing an appropriate dot pattern for light extraction on one surface of the solid blank nano-layered slab; and cutting and finishing the printed nano-layered slab to form the nano-layered light guide plate, comprising a plurality of two or more different alternating material layers, with each layer having a thickness of less than a quarter wavelength of visible light.

In another embodiment, the present invention provides a method of manufacturing a nano-layered light guide plate comprising: forming by a coextrusion method a multi-layered molten sheet comprising a plurality of two or more different alternating material layers; casting the coextruded sheet onto a flat surface to create a blank nano-layered slab; hot embossing a light extraction micro-pattern on one surface of the cast blank nano-layered slab; cooling the micro-patterned surface to below the effective glass transition temperature of the nano-layered slab; and cutting and finishing the micro-patterned nano-layered slab to form the nano-layered light guide plate, comprising a plurality of two or more different alternating material layers with each layer having a thickness of less than a quarter wavelength of visible light.

### BRIEF DESCRIPTION OF THE DRAWINGS

FIG. 1 is a schematic perspective view of an exemplary embodiment of a display apparatus using the nano-layered light guide plate of the present invention;

FIGS. 2A and 2B show a bottom view and a side view of a light guide plate;

FIG. 3A shows an expanded side view of the light guide plate in a backlight unit viewed in a direction parallel to the width direction;

FIG. 3B shows an expanded side view of the light guide plate viewed in a direction parallel to the length direction;

FIG. 3C is a top view of linear prisms on the light guide plate;

FIG. 3D is a top view of curved wave-like prisms on the light guide plate;

FIGS. 4A-1, 4A-2, and 4A-3 show perspective, top, and side views of the first kind of discrete elements;

FIGS. 4B-1, 4B-2, and 4B-3 show perspective, top, and side views of the second kind of discrete elements; and

FIGS. 4C-1, 4C-2, and 4C-3 show perspective, top, and side views of the third kind of discrete elements;

FIG. 5 is a schematic representation of an apparatus for preparing the multi-layered molten sheet used to produce the nano-layered light guide plate of the present invention; and

FIG. 6 is a schematic of one exemplary embodiment of a fabrication apparatus for forming the nano-layered light guide plate of the present invention utilizing the extrusion roll molding process.

### DETAILED DESCRIPTION OF THE INVENTION

The present invention meets those needs by providing a multi-layered light guide plate comprising a plurality of at least two alternating layers (for example, A/B/A/B/ . . . ) of polymeric materials A and B, wherein the alternating layers are aligned parallel to the principal surfaces of the light guide plate; and whereupon one or both principal surfaces there is disposed a micro-pattern to enable extraction of light from a light source and redirecting the light outwardly toward the liquid crystal panel. The thicknesses of the alternating layers A and B (corresponding to polymers A and B) may vary as long as the thickness of any of the alternating layers is less than a quarter wavelength of visible light, or about 100 nanometers (nm). The multi-layered light guide plate may comprise a plurality of more than two alternating polymeric layers (for example, A/B/C/A/B/C/ . . . ), but all layers must be less than a quarter wavelength of visible light in thickness, or <˜100 nm. As used herein, such a multi-layered light guide plate shall be referred to as nano-layered light guide plate.

The nano-layered light guide plate is an effective medium composite with its physical properties being some linear combination of the properties of the component materials (A, B, C, etc.). Thus, the optical, mechanical and thermal properties of the nano-layered light guide plate will be some intermediate of the properties of its component materials (A, B, C, etc.) depending on the relative thicknesses of the alternating layers. The effective properties of the nano-layered light guide plate can be varied and optimized for a specific function by the choice of the constituent materials and by adjusting the relative thicknesses of the alternating layers.

In one embodiment the nano-layered light guide plate of the present invention is prepared in steps of: forming by a coextrusion method a multi-layered molten sheet comprising a plurality of alternating layers of at least two different materials (for example, A/B/A/B/ . . . with polymers A and B being preferably, but not exclusively, PC and PMMA); casting the multi-layered molten sheet onto a carrier film substrate and into the nip between a pressure roller and a pattern roller, the pattern roller having an appropriate micro-pattern to be transferred to the surface of the cast multi-layered sheet. The pressure roller and the pattern roller are maintained at certain surface temperatures needed to achieve good replication of the features to be transferred from the pattern roller to the surface of the coextruded sheet. The coextruded sheet is then stripped from the pattern roller, peeled from the carrier film substrate and conveyed to a finishing station for final cutting and finishing of the coextruded patterned sheet to the final dimensions of the nano-layered light guide plate.

In another embodiment, the nano-layered light guide plate of the present invention is prepared in steps of: forming by a coextrusion method a multi-layered molten sheet comprising a plurality of alternating layers of at least two different materials (for example, A/B/A/B/ . . . with polymers A and B being preferably, but not exclusively, PC and PMMA); casting the multi-layered molten sheet onto a micro-patterned carrier film substrate and into the nip between a pressure roller and a pattern roller, the pattern roller and the carrier film having appropriate micro-patterns to be transferred to both surfaces of the cast multi-layered sheet. The pressure roller and pattern roller are maintained at certain surface temperatures needed to achieve good replication of the features to be transferred from the pattern roller and the carrier film to the principal surfaces of the coextruded sheet; the coextruded sheet having micro-patterns on both surfaces is then stripped from the pattern roller, peeled from the carrier film substrate and conveyed to a finishing station for final cutting and finishing of the coextruded patterned sheet to the specified dimensions of the nano-layered the light guide plate.

In another embodiment, the nano-layered light guide plate of the present invention is prepared in steps of: forming by a coextrusion method a multi-layered molten sheet comprising a plurality of alternating layers of at least two different materials (for example, A/B/A/B/ . . . with polymers A and B being preferably, but not exclusively, PC and PMMA); casting the multi-layered molten sheet onto a flat surface to create a solid blank nano-layered sheet; printing an appropriate dot pattern for efficient light extraction on one surface of the blank solid nano-layered sheet using ink jet, screen printing or other known printing method; UV curing the printed ink if necessary; cutting and finishing the printed nano-layered sheet to the specified dimensions of the nano-layered light guide plate.

In yet another embodiment, the nano-layered light guide plate of the present invention is prepared in steps of: forming by a coextrusion method a multi-layered molten sheet comprising a plurality of alternating layers of at least two different materials (for example, A/B/A/B/ . . . with polymers A and B being preferably, but not exclusively, PC and PMMA); casting the multi-layered molten sheet onto a flat surface to create a solid blank nano-layered sheet; hot embossing a light extraction micro-pattern on one of the principal surfaces of the cast sheet by means of appropriate hot press with a mold having a negative replica of the light extraction micro-pattern; cutting and finishing the printed nano-layered sheet to the specified dimensions of the nano-layered light guide plate.

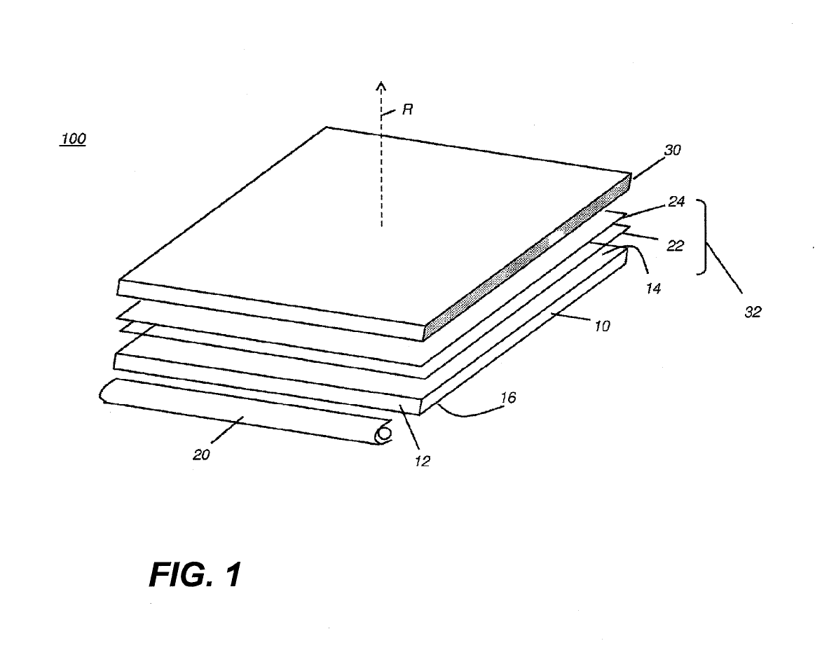

Referring now to FIG. 1 there is shown a display apparatus 100 that uses light guide plate 10 as part of a backlight assembly 32. Light from light source assembly 20 is coupled to light guide plate 10 through input surface 12. A display panel 30, such as an LCD panel, modulates light emitted from light output surface 14 of light guide plate 10 in the backlight assembly 32. One or more additional films, shown as films 22 and 24 in FIG. 1 may also be provided as part of the backlight assembly 32 for improving the direction, uniformity, or other characteristic of light emitted from the light guide plate 10 or to provide polarization to the light passing through the LCD panel 30. The path of light through the display panel is shown as dashed arrow R. Light extraction and redirection by the light guide plate 10 is facilitated by an array of discrete microscopic features disposed, typically but not exclusively, on its bottom surface 16. A light reflector is also commonly disposed under the light guide plate 10, adjacent to featured surface 16, to improve light extraction efficiency from the light source. The output surface 14 and bottom or featured surface 16 shall be referred to as the principal surfaces of the light guide plate.

Light guide plates or films in LCD backlights and general illumination devices have a general function of converting light emanating from a point-like light source, a plurality of point-like light sources such as light emitting diodes (LEDs) or a line light source such as a cold cathode fluorescent lamp (CCFL), into a planar or curved light emitting surface. It is desired that the light be efficiently extracted from the light source(s) and emitted from the output surface as uniformly as possible.

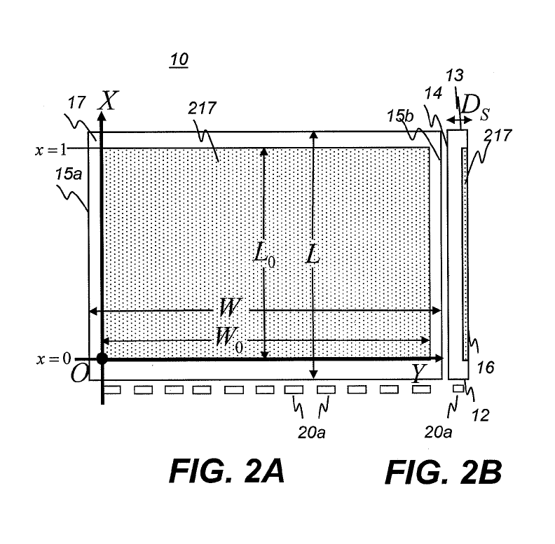

As shown in FIGS. 2A and 2B, light guide plate 10 has a light input surface 12 for coupling light emitted from light source 20a, an output surface 14 for emitting light out of the light guide plate, an end surface 13 which is opposite of the input surface 12, a bottom surface 16 opposite of the output surface 14, and two side surfaces 15a and 15b. Light source 20a can be a single linear light source such as CCFL, a point-like light source such as LED or a plurality of point-like light sources, e.g., LEDs.

The light guide plate of the present invention uses light-extracting micro-structures shaped as discrete elements and placed on one principal surface thereon and, optionally, light-redirecting micro-structures that are generally shaped as continuous prisms and placed on the opposite surface of the light guide plate. True prisms have at least two planar faces. Because, however, one or more surfaces of the light-redirecting structures need not be planar in all embodiments, but may be curved or have multiple sections, the more general term “light redirecting structure” is used in this specification. Typically, but not exclusively, the light extracting micro-pattern 217 is placed on the bottom surface 16, while the light-redirecting structures are positioned on the output surface 14 of the light guide plate.

Light guide plate 10 has a micro-pattern 217 of discrete elements represented by dots on its bottom surface 16. The pattern 217 has a length L₀ and a width W₀, which are parallel and orthogonal, respectively, to the line of light sources 20a. Generally, the pattern 217 has a smaller dimension than light guide plate 10 in the length direction, in the width direction, or in both directions. Namely, L₀≦L and W₀≦W. The size and number of discrete elements may vary along the length direction and the width direction. Alternatively, the pattern 217 can be on the output surface 14 of light guide plate 10.

Generally, the density function of discrete elements D^{2D}(x, y) varies with location (x, y). In practice, the density function D^{2D}(x, y) varies weakly along the width direction, while it varies strongly along the length direction. For simplicity, one dimensional density function D(x) is usually used to characterize a pattern of discrete elements and can be calculated, for example, as D(x)=∫D^{2D}(x, y)dy≈W₀D^{2D}(x,0). Other forms of one-dimensional (1D) density function can also be easily derived from the 2D density function D^{2D}(xx, y). In the following, the independent variable x should be interpreted as any one that can be used to calculate a one-dimensional density function D(x). For example, x can be the radius from the origin O if the light source is point-like and located near the corner of the light guide plate.

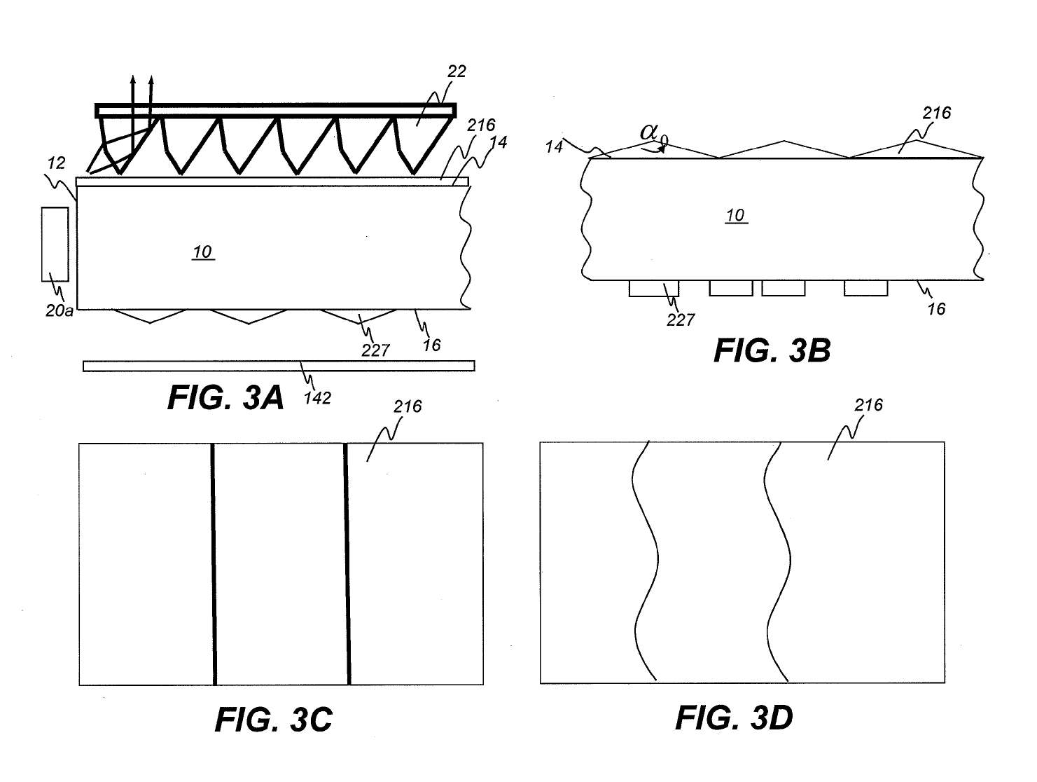

FIG. 3A shows an expanded side view of light guide plate 10, a prismatic film such as a turning film 22 or a diffuser, and a reflective film 142 when viewed in a direction parallel to the width direction. Optionally, on the output surface 14 of light guide plate 10 are a plurality of prisms 216, and on the bottom surface 16 are a plurality of discrete elements 227. FIG. 3B shows an expanded side view of light guide plate 10 when viewed along the length direction. Each prism 216 on the output surface 14 generally has an apex angle α₀. The prism may have a rounded apex and may be substituted by a lenticular pattern. FIG. 3C is a top view of prisms 216. In this example, the prisms are parallel to each other. In another example, shown in FIG. 3D, the prisms 216 are curved or wave-like. Prisms or lenticular (rounded) elements with any known modification may be used in the present invention. Examples include, but are not limited to, prisms with variable height, variable apex angle, and variable pitches. Most commonly, however, the output surface of the light guide plate is flat and featureless.

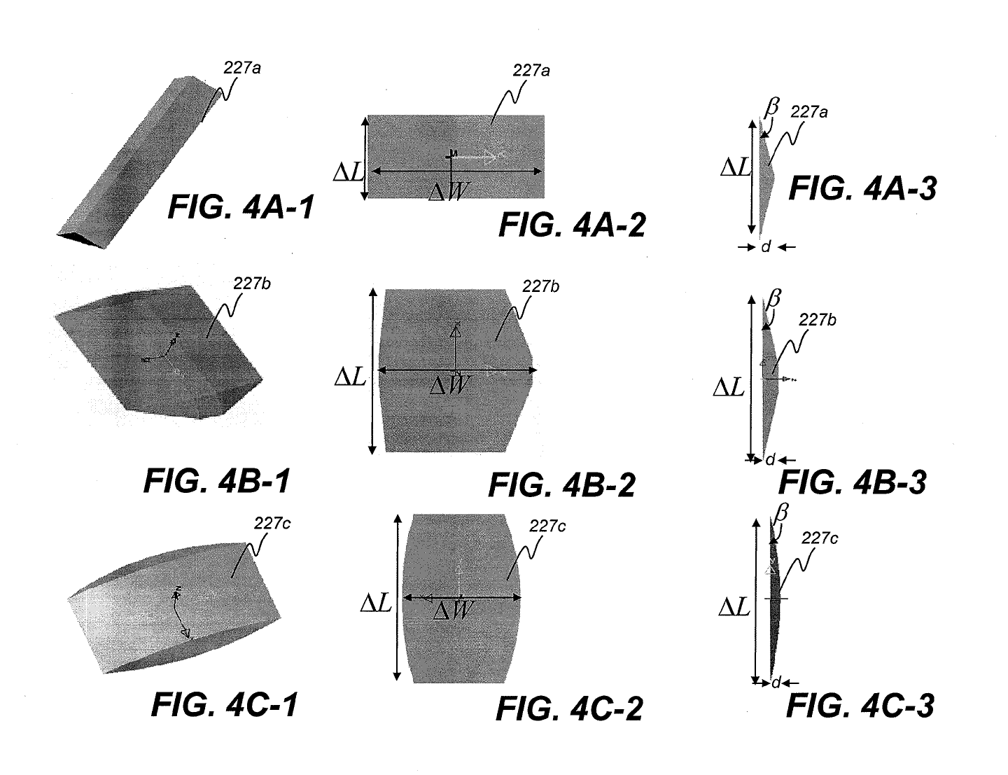

FIGS. 4A-1, 4A-2, and 4A-3 show perspective, top, and side views, respectively, of one kind of discrete elements 227a that can be used according to the present invention. Each discrete element is essentially a triangular segmented prism. FIGS. 4B-1, 4B-2, and 4B-3 show perspective, top, and side views, respectively, of a second kind of discrete elements 227b that can be used according to the present invention. Each discrete element is essentially a triangular segmented prism with a flat top. FIGS. 4C-1, 4C-2, and 4C-3 show perspective, top, and side views, respectively, of a third kind of discrete elements 227c that can be used according to the present invention. Each discrete element is essentially a rounded segmented prism. Discrete elements of other known shapes such as cylinders, hemispheres and spherical sections can also be used. They may or may not be symmetrical.

The choice of polymeric materials for use in light guide plates for LCD backlights and for general illumination devices is dictated by the demanding optical and physical performance requirements of the waveguide and the display. Since all light guide plates need to transmit light over relatively long distances, light absorption and chromaticity effects within the visible spectrum are particularly critical to the ability of the light guide plate to extract light efficiently, with minimal absorption losses and without changing the color of the light emitted from the output surface. Additionally, the relatively thin light guide plate must be sufficiently sturdy, tough and abrasion resistant to minimize cracking and abrasion-type defects that may be caused by the relative movement of light management films adjacent to the surface of the light guide plate. Finally, the light guide plate must be environmentally stable and low in cost requiring the use of relatively inexpensive and environmentally stable materials. All these critical requirements limit the choice of materials for use in the fabrication of light guide plates to very few practically useful material options. As noted, two leading resin classes used today in light guide plates in LCD backlights and in general illumination devices are poly(methyl methacrylate) (PMMA) and bis-phenol A polycarbonate (PC). Each of these materials has special strengths but each also suffers from a number of serious drawbacks. For example, while PMMA has excellent optical properties and very high abrasion resistance, it is very brittle and has borderline environmental stability. By comparison, PC has excellent mechanical properties and good environmental stability but its optical properties are somewhat inferior to those of PMMA and its abrasion resistance is poor. Also, not all plastic materials can be reliably fabricated to thin gauges without risk of brittleness and cracking. For example, PMMA, although mentioned in the '054 Rinko patent, would prove difficult to fabricate at a thickness below 0.3 mm. Fabrication methods for this solution would also be challenging using existing processing technology and conventional materials.

The present invention provides a multi-layered polymeric light guide plate made up of alternating layers of at least two different optical materials (for example, layer structure of A/B/A/B . . . with polymers A and B) wherein all layers are less than a quarter wavelength of light in thickness and are generally parallel to the principal surfaces of the light guide plate; and wherein one or both principal surfaces (surfaces 16 and/or 14 in FIG. 1) contains a pattern to enable extraction and redirection of light by the light guide plate from a light source or multiple light sources placed at one or multiple edges of the light guide plate. The multiple, alternating layers can comprise from about a hundred to several thousand different layers. To minimize undesirable scattering losses and waveguiding within the multi-layered structure, the thickness of the alternating layers may vary, but no layer may be greater in thickness than a quarter wavelength of visible light, typically <100 nm. For some special applications the thickness range may be expanded to <150 nm. If any of the alternating layers is thicker than a quarter wavelength of visible light, the light will be trapped within the multi-layered film and thus adversely impact the light extraction efficiency of the light guide plate. The multi-layered light guide plate of the present invention having alternating layers of at least two different polymers and with the layers being less than a quarter wavelength of visible light, or less than ˜100 nm, in thickness, will be referred to as nano-layered light guide plate.

The nano-layered light guide plate is an effective medium composite film or sheet with its effective physical properties being some linear combination of the properties of the component materials (A, B, C, etc.). Thus, the optical, mechanical and thermal properties of the nano-layered light guide plate will be some intermediate of the properties of its component materials (A, B, C, etc.) depending on the relative thicknesses of the alternating layers. Using the effective medium theory, the optical and other physical properties (p) of a nano-layered film with two alternating layers, A and B, can be expressed as:

p=p_{A}x+p_{B}(1−x)

where x is the thickness fraction of layer A. A similar expression can be applied to nano-layered films with more than two alternating layers and with various structures such as A/B/C/D/ . . . , A/B/C/B/A/ . . . , and the like. In the latter structure layer C may be used as a tie layer to improve interlayer adhesion between layers A and B. Thus, the effective properties of the nano-layered light guide plate can be varied and optimized for a specific function or application by judicious selection of the alternating materials and by adjusting the relative thicknesses of the alternating layers while keeping the thicknesses of any and all layers <150 nm and more preferably <100 nm per layer. For example, if the two alternating materials in the nano-layered light guide plate are polycarbonate (PC) and poly(methyl methacrylate) (PMMA), the physical properties of the light guide plate will be some linear combination of the properties of PC and PMMA. Consequently, the scratch and mar sensitivity of the nano-layered structure would be improved relative to those of PC. Likewise, the optical properties of the composite structure, especially light transmittance and chromaticity are also expected to improve relative to those of PC because of the presence of the optically superior PMMA layers in the multi-layered structure. It also follows that the brittleness and environmental shortcomings of PMMA are expected to improve with the addition of alternating layers of PC due to its higher glass transition temperature, higher toughness and lesser sensitivity to moisture.

### Materials

Although PMMA and PC are particularly suitable for use in the nano-layered light guide plate of the present invention, many other optically transparent materials, and generally more than two alternating materials, may be used in the nano-layered structure. The nano-layered light guide plate of the present invention may be formed from any combination of various types of transparent polymers that are melt-processable. These materials may include, but are not limited to, homopolymers, copolymers, and oligomers that can be further processed into polymers from the following families: polyesters; polyarylates; polycarbonates (e.g., polycarbonates containing moieties other than of bisphenol A); polyamides; polyether-amides; polyamide-imides; polyimides (e.g., thermoplastic polyimides and polyacrylic imides); polyetherimides; cyclic olefin polymers; impact modified polymethacrylates, polyacrylates, poly(acrylonitriles) and polystyrenes; copolymers and blends of styrenics (e.g., styrene-butadiene copolymers, styrene-acrylonitrile copolymers, and acrylonitrile-butadiene-styrene terpolymers); polyethers (e.g., polyphenylene oxide, poly(dimethylphenylene oxide); cellulosics (e.g., ethyl cellulose, cellulose acetate, cellulose propionate, cellulose acetate butyrate, and cellulose nitrate); and sulfur-containing polymers (e.g., polyphenylene sulfide, polysulfones, polyarylsulfones, and polyethersulfones). Optically transmissive, miscible blends or alloys of two or more polymers or copolymers may also be used.

Suitably, under some embodiments, the nano-layered light guide plate may comprise a melt-processable, flexible polymer. For the purpose of the present invention, a flexible polymer is a polymer that in a film or sheet form can be wound under a typical service temperature range around a cylinder 5 cm in diameter without fracturing. Desirably, the light guide plate may comprise polymeric materials having a combined effective light transmission of at least 85 percent (ASTM D-1003), more desirably at least 90 percent and a haze (ASTM D-1003) no greater than 2 percent, more desirably no greater than 1 percent. In general, suitable polymers may be crystalline, semi-crystalline, or amorphous in nature, but amorphous polymers are most suitable due to their ability to form optically homogeneous structures with minimal levels of haze. To best meet thermal dimensional stability requirements for display and general illumination applications the polymers in the nano-layered light guide plate should have a combined effective glass transition temperature (Tg) (ASTM D3418) of at least 85° C. and a thermal expansion coefficient (ASTM D-696) of no greater than 1.0×10⁻⁴ mm/mm/° C. at ambient temperature. These properties can be significantly improved by selecting the right combination of polymers for use as alternating layers in the nano-layered light guide plate.

Particularly suitable melt-processable polymers for the nano-layered light guide plate of the present invention comprise amorphous polyesters (i.e., polyesters that do not spontaneously form crystalline morphologies under the time and temperatures employed during the extrusion process used to fabricate the nano-layered light guide plates), polycarbonates (i.e., polycarbonates based on dihydric phenols such as bisphenol A), polymeric materials comprising both ester and carbonate moieties, and cyclic olefin polymers. In addition, normally brittle, melt-processable polymers such as poly(methyl methacrylates), polystyrenes, and poly(acrylonitriles), are suitable materials for use in the present invention after being made flexible by the incorporation of impact modifier polymer particles (for example, impact modified PMMA that comprises soft core/hard shell latex particles), provided the impact modifier does not degrade the optical properties of the nano-layered composite to the point of not meeting the optical requirements of the light guide plate. Flexibility of the polymeric layer is desirable but not necessary for practicing this invention. Various types of nano-composites, comprising a matrix polymer blended with nano-particles whose dimensions are much smaller than the thickness of the coextruded layer may also be used in one or more alternating layers in the nano-layered structure, provided the optical properties of the nano-layered light guide plate made therefrom, are not adversely impacted by the addition of nano-particles.

Suitable monomers and comonomers for use in polyesters may be of the diol or dicarboxylic acid or ester type. Dicarboxylic acid comonomers include, but are not limited to, terephthalic acid, isophthalic acid, phthalic acid, all isomeric naphthalenedicarboxylic acids, bibenzoic acids such as 4,4′-biphenyl dicarboxylic acid and its isomers, trans-4,4′-stilbene dicarboxylic acid and its isomers, 4,4′-diphenyl ether dicarboxylic acid and its isomers, 4,4′-diphenylsulfone dicarboxylic acid and its isomers, 4,4′-benzophenone dicarboxylic acid and its isomers, halogenated aromatic dicarboxylic acids such as 2-chloroterephthalic acid and 2,5-dichloroterephthalic acid, other substituted aromatic dicarboxylic acids such as tertiary butyl isophthalic acid and sodium sulfonated isophthalic acid, cycloalkane dicarboxylic acids such as 1,4-cyclohexanedicarboxylic acid and its isomers and 2,6-decahydronaphthalene dicarboxylic acid and its isomers, bi- or multi-cyclic dicarboxylic acids (such as the various isomeric norbornene and norborene dicarboxylic acids, adamantane dicarboxylic acids, and bicyclo-octane dicarboxylic acids), alkane dicarboxylic acids (such as sebacic acid, adipic acid, oxalic acid, malonic acid, succinic acid, glutaric acid, azelaic acid, and dodecane dicarboxylic acid.), and any of the isomeric dicarboxylic acids of the fused-ring aromatic hydrocarbons (such as indene, anthracene, pheneanthrene, benzonaphthene, fluorene and the like). Other aliphatic, aromatic, cycloalkane or cycloalkene dicarboxylic acids may be used. Alternatively, esters of any of these dicarboxylic acid monomers, such as dimethyl terephthalate, may be used in place of or in combination with the dicarboxylic acids themselves.

Suitable diol comonomers include, but are not limited to, linear or branched alkane diols or glycols (such as ethylene glycol, propanediols such as trimethylene glycol, butanediols such as tetramethylene glycol, pentanediols such as neopentyl glycol, hexanediols, 2,2,4-trimethyl-1,3-pentanediol and higher diols), ether glycols (such as diethylene glycol, triethylene glycol, and polyethylene glycol), chain-ester diols such as 3-hydroxy-2,2-dimethylpropyl-3-hydroxy-2,2-dimethylpropyl-3-hydroxy-2,2-dimethyl propanoate, cycloalkane glycols such as 1,4-cyclohexanedimethanol and its isomers and 1,4-cyclohexanediol and its isomers, bi- or multicyclic diols (such as the various isomeric tricyclodecane dimethanols, norbornane dimethanols, norbornene dimethanols, and bicyclo-octane dimethanols), aromatic glycols (such as 1,4-benzenedimethanol and its isomers, 1,4-benzenediol and its isomers, bisphenols such as bisphenol A, 2,2′-dihydroxy biphenyl and its isomers, 4,4′-dihydroxymethyl biphenyl and its isomers, and 1,3-bis(2-hydroxyethoxy)benzene and its isomers), and lower alkyl ethers or diethers of these diols, such as dimethyl or diethyl diols. Other aliphatic, aromatic, cycloalkyl and cycloalkenyl diols may be used.

The polymeric materials comprising both ester and carbonate moieties may be a (miscible) blend where at least one component is a polymer based on a polyester (either homopolymer or copolymer) and the other component is a polycarbonate (either homopolymer or copolymer). Such blends may be made by, for example, conventional melt processing techniques, wherein pellets of the polyester are mixed with pellets of the polycarbonate and subsequently melt blended in a single or twin screw extruder to form a homogeneous mixture. At the melt temperatures some transreaction (transesterification) may occur between the polyester and polycarbonate, the extent of which may be controlled by the addition of one or more stabilizers such as a phosphite compound. Alternatively, the polymeric materials comprising both ester and carbonate moieties may be a copolyestercarbonate prepared by reacting a dihydric phenol, a carbonate precursor (such as phosgene), and a dicarboxylic acid, dicarboxylic acid ester, or dicarboxylic halide.

Cyclic olefin polymers are a fairly new class of polymeric materials that provide high glass transition temperatures, high light transmission, and low optical birefringence. Amorphous cyclic olefin polymers useful in the practice of the present invention include homopolymers and copolymers. The cyclic olefin (co)polymers include, for example, cyclic olefin addition copolymers of non-cyclic olefins such as α-olefins with cyclic olefins; cyclic olefin addition copolymers of ethylene, cyclic olefins and α-olefins; and homopolymers and copolymers prepared by ring opening polymerization of cyclic monomers followed by hydrogenation. Preferred cyclic olefin polymers are those composed of a cyclic olefin having a norbornene or tetracyclododecene structure. Typical examples of preferable cyclic olefin polymers and copolymers include, norbornene/ethylene copolymer, norbornene/propylene copolymer, tetracyclododocene/ethylene copolymer and tetracyclododocene/propylene copolymer. Current commercially available cyclic olefin polymers include, APEL™ (Mitsui Chemical Inc.), ARTON® (JSR Corporation), TOPAS® (Ticona GmbH), and Zeonex® and Zeonor® (Zeon Chemical Corporation). While the optical properties of this class of polymers are generally highly suitable for use in light guide plates, they are relatively high in cost and often quite brittle. Thus, by combining these materials with less expensive polymers such as PMMA or PC it may be possible to mitigate some of the drawbacks of this class of optical materials and produce a nano-layered light guide plate with a good balance of optical and physical properties.

### Fabrication

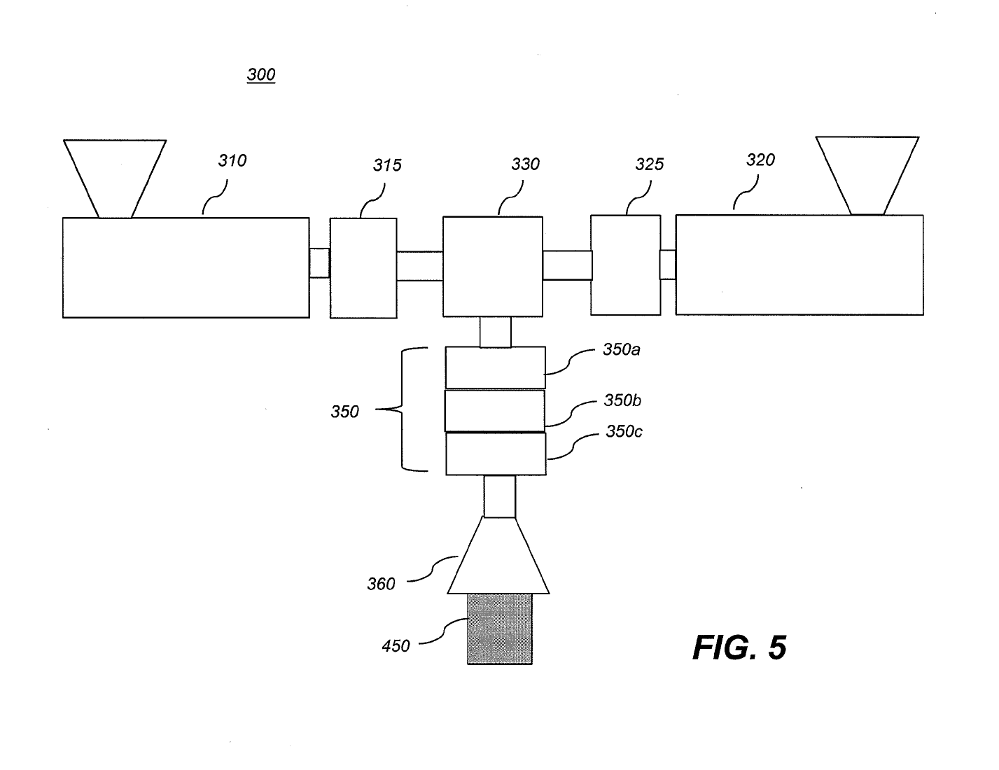

The nano-layered light guide plate of the present invention can be fabricated using several melt extrusion casting methods. In all cases, the first step in the process involves the preparation of a coextruded multi-layered molten sheet with the desired layered composition. As noted below, by adding a number of layer multiplying elements along the melt stream, it is possible to increase the number of layers and, correspondingly, reduce the layer thickness to the desirable level. Because of expected draw-down during the casting of the coextruded multi-layered molten sheet, the layer thickness at this step may exceed the required upper limit of 100 nm in the final nano-layered light guide plate. An extrusion apparatus 300 for the preparation of the multilayer article of the present invention is illustrated schematically in FIG. 5 wherein first, second, and optionally third or more extruders (310, 320, respectively, in case of two alternating layers and two extruders) are used to generate separate melt streams for the different polymers to be fed into a feedblock coextrusion die 330 after passing optionally through appropriate melt pumps 315 and 325. An optional third extruder may be used when it is desired to produce a light guide plate having more than two alternating layers such as A/B/C/A/B/C/ . . . or A/B/C/B/A/B/C/B/ . . . and the like. The third polymer may differ in its optical and physical properties from the first and second polymers. In one embodiment, the third polymer may comprise a copolymer of the first and second polymers and serve as an effective tie layer to enhance interlayer adhesion between the first and second layers. It is optional to use more than three extruders and more than three alternating layers. While a coextrusion feedblock die 330 is illustrated, it will be appreciated by those skilled in the art that other types of coextrusion dies may be used to extrude the multi-layered film.

The layered coextrudate exiting the coextrusion feedblock die 330 is passed through a series of layer multiplying elements 350 designed to increase the number of layers and simultaneously decrease the layer thicknesses. Three multiplying elements (350a, 350b, 350c) are shown schematically in FIG. 5 but the number of multiplying elements may be varied arbitrarily depending on the total number of layers needed to be generated in the multi-layered structure. In the case of a multi-layered structure with two alternating layers, A and B, the number of layers m is given by the formula:

m=2ⁿ

where n is the number of multiplying elements. Thus, for a sufficient number of layer multiplying elements it is possible to increase the number of layers and correspondingly reduce the thickness of the layers to lie within the desired range, i.e., <150 nm and more preferably <100 nm. After passing through the layer multiplying elements the melt stream passes through an appropriate sheeting die 360 wherein the final shape of the multi-layered molten coextrudate 450 is adjusted before casting.

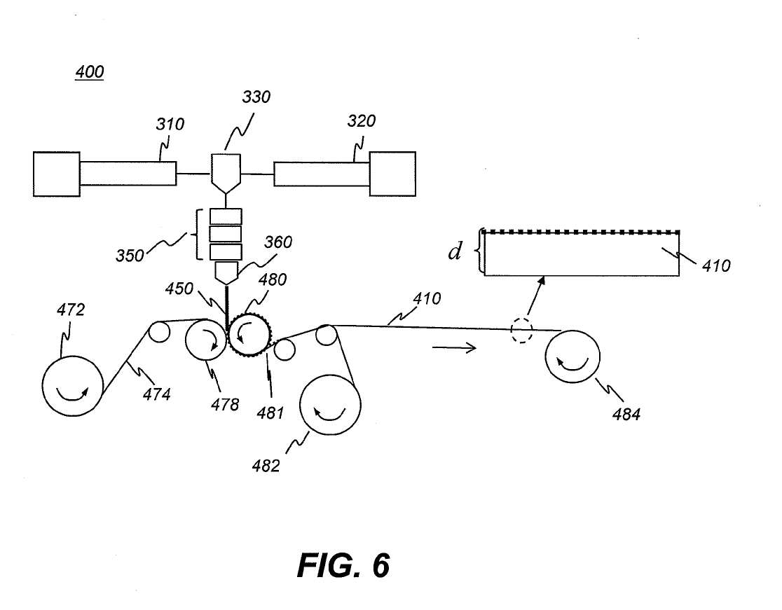

After preparation of the coextruded multi-layered molten sheet, the patterning of one or both principal surfaces of the sheet, as required for the preparation of the nano-layered light guide plate of the present invention, can follow a number of different process embodiments. Some exemplary embodiments are described below. In one embodiment, the patterning of one or both principal surfaces of the multi-layered sheet produced by the multi-layer coextrusion process, follows the so-called extrusion roll molding process, illustrated schematically in FIG. 6. The process described herein below is particularly suitable for web manufacturing and roll-to-roll operations and is readily adaptable to the manufacture of the nano-layered light guide plate of the present invention. In one of its embodiments, this process comprises the steps of:

1) The multi-layered polymeric sheet exiting from extrusion apparatus 400 is castonto a stiff but flexible polymeric carrier film 474 fed from a supply roller 472 into the nip between two counter-rotating rollers 480 and 478. Roller 480, the pattern roller, is featured with a micro-pattern on its surface, with the pattern designed to be transferred to the light guide plate and used to extract light from the light source(s). The surface temperature T_{PaR,1} of roller 480 is maintained such that T_{PaR,1}>Tg₁−50° C., where Tg₁ is the effective glass transition temperature of the extruded nano-layered polymeric sheet 450 based on the effective medium theory. Roller 478, the pressure roller, has a soft elastomeric surface and a surface temperature T_{P,1}, where T_{P,1}<T_{PaR,1}. The nip pressure P between the two rollers is maintained such that P>8 Newtons per millimeter of roller width. Many types of carrier films can be used in the practice of the present invention but a common example of a carrier is poly(ethylene terephthalate) (PET) film which possesses the right combination of flexibility, stiffness, ruggedness and low cost.
(2) The carrier film 474 and the cast multi-layered polymeric sheet 450 issuing from the nip region adhere preferentially to the pattern roller 480 forming a multi-layered polymeric sheet with a desired thickness until solidifying some distance downstream from the nip.
(3) The solidified multi-layered sheet 410 is stripped from pattern roller 480, at a stripping point 481, peeled from the carrier film; the carrier film 474 once separated from the solidified multi-layered sheet is wound onto take-up roller 482. The solidified multi-layered sheet 410 once stripped from pattern roller 480 and separated from carrier film 474 is taken up under controlled tension into a take-up station where the sheet is either finished (sheeted) in-line or wound on roller 484, for finishing at a later time, to produce the nano-layered light guide plate of the present invention. The patterned nano-layered light guide plate has a thickness, d, which typically varies from 0.20 to 5.0 mm, although for the extrusion roll molding process d is preferably in the range of between about 0.20 to 0.8 mm, and more preferably in the range of between about 0.3 mm to 0.7 mm. The use of a carrier film 474 in making the multi-layered polymeric article is optional in some cases, although controlling the quality of the manufactured light guide plate without the use of a carrier film, would be generally more difficult.

The nano-layered light guide plate of the present invention can be prepared in a single patterning step with patterns on both surfaces by placing patterns on both the pattern roller 480 and the pressure roller 478 and without the use of a carrier film. Because of the short residence time and contact time of the resin with the patterned pressure roller 478 in the nip region, it is preferred that the pattern transferred from the pressure roller 478 be easy to replicate (e.g., very shallow features) in order to achieve acceptable replication fidelity on both sides of the patterned sheet. Additionally, by manipulating the alternating resins such that placing a layer of a resin on the side of the pressure roller with easier replication and forming characteristics, it is possible to achieve better replication at shorter contact times. Examples of resins that can be useful in this aspect are polymers similar in composition to the bulk polymers used in the nano-layered light guide plate but with lower molecular weight, or resins formulated with appropriate plasticizers. An alternative way to pattern the second surface of the nano-layered light guide plate is to use a patterned carrier film 474, with the requisite pattern to be transferred to the other principal surface of the multi-layered cast sheet in the nip region and that can be readily peeled off from the formed nano-layered light guide plate downstream of the stripping point 481.

In another embodiment of the surface patterning step, the nano-layered light guide plate of the present invention is prepared in steps of:

(1) Forming by a coextrusion method a multi-layered molten sheet comprising a plurality of alternating layers of at least two different materials (for example, A/B/A/B/ . . . with polymers A and B being preferably, but not exclusively, PC and PMMA);
(2) Casting the multi-layered molten sheet onto a flat surface and cooling said sheet to create a solid blank nano-layered sheet or slab;
(3) Printing an appropriate dot pattern for efficient light extraction on one surface of the solid blank nano-layered cast sheet by means of ink jet, screen printing or other known printing method. In a preferred embodiment a UV curable ink is used but other types of ink are possible to use in this step;
(4) UV curing of the printed ink if necessary.
(5) Cutting and finishing the printed nano-layered sheet to the final dimensions of the light guide plate of the present invention.

In yet another embodiment, the nano-layered light guide plate of the present invention is prepared in steps of:

(1) Forming by a coextrusion method a multi-layered molten sheet comprising a plurality of alternating layers of at least two different materials (for example, A/B/A/B/ . . . with polymers A and B being preferably, but not exclusively, PC and PMMA);
(2) Casting the multi-layered molten sheet onto a flat surface to create a blank nano-layered sheet or slab;
(3) Hot embossing a light extraction micro-pattern on one of the principal surfaces of the cast sheet by means of appropriate hot press with a mold having a negative replica of the light extraction micro-pattern. In order to achieve good replication of the mold pattern the temperature of the embossed surface must be raised above the effective glass transition temperature of the nano-layered sheet;
(4) Cooling the patterned surface to below the effective glass transition temperature of the nano-layered sheet;
(5) Cutting and finishing the patterned nano-layered sheet to the final dimensions of the light guide plate of the present invention.

It is noted that the extrusion roll molding process is generally limited to relatively thin light guide plates (d<0.8 mm) while the exemplary printing and hot embossing processes described above are better suited for preparing relatively thick light guide plates (d≧0.8 mm).

Thus, what is provided in the present invention is a nano-layered light guide plate comprising a plurality of alternating layers of coextruded polymeric, thermoplastic materials wherein the alternating layers are less than a quarter wavelength of visible light in thickness and are generally parallel to the principal surfaces of the light guide plate; and wherein one or both principal surfaces contain a pattern to enable extraction and redirection of light by the light guide plate from a light source or multiple light sources placed at one or multiple edges of the light guide plate. This light guide plate can be used in LCD backlights as well as in general illumination applications and thus the light extracted by the light guide plate can be directed towards the LCD panel or the illuminated area in case of a general illumination device.

1. A method of manufacturing a nano-layered light guide plate comprising:
forming by a coextrusion method a multi-layered molten sheet comprising a plurality of two or more different alternating material layers;
casting the coextruded sheet into a nip between a pressure roller and a pattern roller to form a nano-layered sheet having a discrete micro-pattern on at least one principal surface thereof; and
cutting and finishing the extruded micro-patterned sheet to form the nano-layered light guide plate, comprising a plurality of two or more different alternating material layers, with each layer having a thickness of less than a quarter wavelength of visible light.

2. The method of claim 1 wherein the alternating material layers are of the recurring A/B/A/B/ . . . type, and with the A and B layers comprising two different optical polymers.

3. The method of claim 1 wherein the alternating material layers are of the recurring A/B/C/A/B/C/ . . . type, and with the A, B and C layers comprising three different optical polymers.

4. The method of claim 1 wherein the alternating material layers are less than 150 nm thick, and more preferably, less than 100 nm thick.

5. The method of claim 1 wherein the alternating material layers are of the recurring A/C/B/C/A/C/B/C . . . type, and with the A, B and C layers comprising three different optical polymers.

6. The method of claim 1 wherein the alternating material layers comprise different optically transmissive polymers including, but are not limited to, poly(methyl methacrylate) or other acrylic polymers, polycarbonates, polyesters, polycycloolefins and other amorphous olefinic polymers, polyamides, polyimides, styrenics, polyurethanes, polysulfones, and copolymers or blends thereof.

7. The method of claim 1 wherein the nano-layered light guide plate further comprises a continuous micro-pattern on the side opposite the principal surface.

8. A method of manufacturing a nano-layered light guide plate comprising:
forming by a coextrusion method a multi-layered molten sheet comprising a plurality of two or more different alternating material layers;
casting the coextruded sheet onto a flat surface and cooling the sheet to create a solid blank nano-layered slab;
printing an appropriate dot pattern for light extraction on one surface of the solid blank nano-layered slab; and
cutting and finishing the printed nano-layered slab to form the nano-layered light guide plate, comprising a plurality of two or more different alternating material layers, with each layer having a thickness of less than a quarter wavelength of visible light.

9. A method of manufacturing a nano-layered light guide plate comprising:
forming by a coextrusion method a multi-layered molten sheet comprising a plurality of two or more different alternating material layers;
casting the coextruded sheet onto a flat surface to create a blank nano-layered slab;
hot embossing a light extraction micro-pattern on one surface of the cast blank nano-layered slab;
cooling the micro-patterned surface to below the effective glass transition temperature of the nano-layered slab; and
cutting and finishing the micro-patterned nano-layered slab to form the nano-layered light guide plate, comprising a plurality of two or more different alternating material layers with each layer having a thickness of less than a quarter wavelength of visible light.
